(19) United States
(12) Patent Application Publication
(10) Pub. No.: US 2026/0039436 A1
(43) Pub. Date: Feb. 5, 2026

(54) ENHANCED CHANNEL ESTIMATION IN TELECOMMUNICATION SYSTEMS

(71) Applicant: Nokia Technologies Oy, Espoo (FI)

(72) Inventors: Nhat-Quang NHAN, Massy (FR); Alessio MARCONE, Munich (DE); Marco MASO, Massy (FR); Keeth Saliya Jayasinghe LADDU, Espoo (FI)

(21) Appl. No.: 19/101,531

(22) PCT Filed: Apr. 19, 2023
(86) PCT No.: PCT/EP2023/060102

§ 371 Date: Feb. 5, 2025

(30) Foreign Application Priority Data
Aug. 12, 2022 (FI) 20225724

(51) Int. Cl. H04L 5/00; H04L 5/14

(52) U.S. Cl. CPC H04L 5/0051; H04L 5/14

(57) ABSTRACT

According to an example aspect of the present disclosure, there is provided an apparatus comprising means for receiving, from a wireless network node, a configuration configuring the apparatus to transmit uplink transmissions using at least two different reference signal resource sets, at least two different spatial settings or at least two different power control parameters sets, means for determining a mapping pattern for transmitting said uplink transmissions using the at least two different reference signal resource sets, the at least two different spatial settings or the at least two different power control parameters sets, wherein the mapping pattern depends at least on whether joint channel estimation is enabled or disabled for the apparatus and means for transmitting said uplink transmissions using the at least two different reference signal resource sets, the at least two different spatial settings or the at least two different power control parameters sets in accordance with the determined mapping pattern.

### FIELD

Various example embodiments relate in general to telecommunication systems and more specifically, to enabling joint channel estimation in such systems.

### BACKGROUND

Channel estimation may be used to enhance operation of wireless communication systems. Channel estimation may be used for example in various cellular communication networks, such as, in cellular communication networks operating according to 5G radio access technology. 5G radio access technology may also be referred to as New Radio, NR, access technology. 3rd Generation Partnership Project, 3GPP, develops standards for 5G/NR and one of the topics in the 3GPP discussions is related to joint channel estimation. According to the discussions there is a need to provide enhanced methods, apparatuses and computer programs related to joint channel estimation in cellular communication networks. Such enhancements may also be beneficial in other wireless communication networks, such as in 6G networks in the future, as well.

### SUMMARY

According to some aspects, there is provided the subject-matter of the independent claims. Some example embodiments are defined in the dependent claims.

The scope of protection sought for various example embodiments of the disclosure is set out by the independent claims. The example embodiments and features, if any, described in this specification that do not fall under the scope of the independent claims are to be interpreted as examples useful for understanding various example embodiments of the disclosure.

According to a first aspect of the present disclosure, there is provided an apparatus comprising means for receiving, from a wireless network node, a configuration configuring the apparatus to transmit uplink transmissions using at least two different reference signal resource sets, at least two different spatial settings or at least two different power control parameters sets, means for determining a mapping pattern for transmitting said uplink transmissions using the at least two different reference signal resource sets, the at least two different spatial settings or the at least two different power control parameters sets, wherein the mapping pattern depends at least on whether joint channel estimation is enabled or disabled for the apparatus and means for transmitting said uplink transmissions using the at least two different reference signal resource sets, the at least two different spatial settings or the at least two different power control parameters sets in accordance with the determined mapping pattern. The apparatus of the first aspect may be a user equipment or a control device configured to control the functioning thereof, possibly when installed therein.

Example embodiments of the first aspect may comprise at least one feature from the following bulleted list or any combination of the following features:
wherein the uplink transmissions comprise Physical Uplink Shared Channel, PUSCH, repetitions and the reference signal resource sets comprise Sounding Reference Signal, SRS, resource sets;
wherein the uplink transmissions comprise Physical Uplink Control Channel, PUCCH, repetitions;
the apparatus further comprising means for determining the mapping pattern for transmitting the at least two different reference signal resource sets, the at least two different spatial settings or the at least two different power control parameters sets depending at least on a duplexing mode configured for the apparatus;
wherein the duplexing mode is Time Division Duplexing, TDD, or Frequency Division Duplexing, FDD;
the apparatus further comprising means for determining, when the joint channel estimation is enabled for the apparatus, that the mapping pattern comprises using a first reference signal set or a first spatial setting or a first power control parameters set on a first set of slots and using a second reference signal set or a second spatial setting or a second power control parameters set on a second set of slots, wherein a number of the first set of slots and a number of the second set of slots are larger than two and the second set of slots is subsequent to the first set of slots;
wherein a number of the first set of slots is the same as a number of the second set of slots, and equals a length of one cycle of a TDD pattern, when one TDD pattern is configured for the apparatus or a number of the first set of slots equals a length of one cycle of a first TDD pattern and a number of the second set of slots equals a length of one cycle of a second TDD pattern when two TDD patterns are configured for the apparatus;
wherein a number of the first set of slots is the same as a number of the second set of slots, and equals a number of slots available for uplink transmissions in one cycle of a TDD pattern or a number of the first set of slots equals a number of slots available for uplink transmissions in one cycle of a first TDD pattern and a number of the second set of slots equals a number of slots available for uplink transmissions in one cycle of a second TDD pattern when two TDD patterns are configured for the apparatus;
wherein a number of the first set of slots is the same as a number of the second set of slots, and equals a length of a nominal time domain window configured for the apparatus;
wherein a number of the first set of slots is the same as a number of the second set of slots, and configured by the wireless network node using Radio Resource Control, RRC, signalling;
wherein the first set of slots is within a first actual time domain window and the second set of slots is within a second actual time domain window;
wherein the slots in the first and the second set of slots are consecutive slots;
wherein the slots in the first and the second set of slots are the slots available for uplink transmissions.

According to a second aspect of the present disclosure, there is provided an apparatus comprising means for transmitting, to a User Equipment, UE, a configuration configuring the UE to transmit uplink transmissions using at least two different reference signal resource sets, at least two different spatial settings or at least two different power control parameters sets, means for determining a mapping pattern for receiving using one of the at least two different reference signal resource sets, the at least two different spatial settings or the at least two different power control parameters sets, wherein the mapping pattern depends at least on whether joint channel estimation is enabled or disabled for the UE and means for receiving said uplink transmissions using said one of the at least two different reference signal resource sets, the at least two different spatial settings or the at least two different power control parameters sets in accordance with the determined mapping pattern. The apparatus of the second aspect may be a wireless network node or a control device configured to control the functioning thereof, possibly when installed therein.

According to a third aspect, there is provided a first method comprising, receiving by an apparatus, from a wireless network node, a configuration configuring the apparatus to transmit uplink transmissions using at least two different reference signal resource sets, at least two different spatial settings or at least two different power control parameters sets, determining, by the apparatus, a mapping pattern for transmitting using the at least two different reference signal resource sets, the at least two different spatial settings or the at least two different power control parameters sets, wherein the mapping pattern depends at least on whether joint channel estimation is enabled or disabled for the apparatus and transmitting, by the apparatus, said uplink transmissions using the at least two different reference signal resource sets, the at least two different spatial settings or the at least two different power control parameters sets in accordance with the determined mapping pattern. The first method may be performed by a user equipment or a control device configured to control the functioning thereof, possibly when installed therein.

According to a fourth aspect, there is provided a second method comprising, transmitting by an apparatus, to a User Equipment, UE, a configuration configuring the UE to transmit uplink transmissions using at least two different reference signal resource sets, at least two different spatial settings or at least two different power control parameters sets, determining, by the apparatus, a mapping pattern for receiving using one of the at least two different reference signal resource sets, the at least two different spatial settings or the at least two different power control parameters sets, wherein the mapping pattern depends at least on whether joint channel estimation is enabled or disabled for the UE and receiving, by the apparatus, said uplink transmissions using said one of the at least two different reference signal resource sets, the at least two different spatial settings or the at least two different power control parameters sets in accordance with the determined mapping pattern. The second method may be performed by a wireless network node or a control device configured to control the functioning thereof, possibly when installed therein.

According to a fifth aspect of the present disclosure, there is provided an apparatus comprising at least one processing core, at least one memory including computer program code, the at least one memory and the computer program code being configured to, with the at least one processing core, cause the apparatus at least to receive, from a wireless network node, a configuration configuring the apparatus to transmit uplink transmissions using at least two different reference signal resource sets, at least two different spatial settings or at least two different power control parameters sets, determine a mapping pattern for transmitting said uplink transmissions using the at least two different reference signal resource sets, the at least two different spatial settings or the at least two different power control parameters sets, wherein the mapping pattern depends at least on whether joint channel estimation is enabled or disabled for the apparatus and transmit said uplink transmissions using the at least two different reference signal resource sets, the at least two different spatial settings or the at least two different power control parameters sets in accordance with the determined mapping pattern. The apparatus of the fifth aspect may be a user equipment or a control device configured to control the functioning thereof, possibly 15 when installed therein.

According to a sixth aspect of the present disclosure, there is provided an apparatus comprising at least one processing core, at least one memory including computer program code, the at least one memory and the computer program code being configured to, with the at least one processing core, cause the apparatus at least to transmit, to a User Equipment, UE, a configuration configuring the UE to transmit uplink transmissions using at least two different reference signal resource sets, at least two different spatial settings or at least two different power control parameters sets, determine a mapping pattern for receiving using one of the at least two different reference signal resource sets, the at least two different spatial settings or the at least two different power control parameters sets, wherein the mapping pattern depends at least on whether joint channel estimation is enabled or disabled for the UE and receive said uplink transmissions using said one of the at least two different reference signal resource sets, the at least two different spatial settings or the at least two different power control parameters sets in accordance with the determined mapping pattern. The apparatus of the second aspect may be a wireless network node or a control device configured to control the functioning thereof, possibly when installed therein.

According to a seventh aspect of the present disclosure, there is provided a non-transitory computer readable medium having stored thereon a set of computer readable instructions that, when executed by at least one processor, cause an apparatus to at least to perform the first method. According to an eighth aspect of the present disclosure, there is provided a non-transitory computer readable medium having stored thereon a set of computer readable instructions that, when executed by at least one processor, cause an apparatus to at least to perform the second method.

According to a ninth aspect of the present disclosure, there is provided a computer program comprising instructions which, when the program is executed by an apparatus, cause the apparatus to carry out the first method. According to a tenth aspect of the present disclosure, there is provided a computer program comprising instructions which, when the program is executed by an apparatus, cause the apparatus to carry out the second method.

### BRIEF DESCRIPTION OF THE DRAWINGS

FIG. 1 illustrates an example of a network scenario in accordance with at least some example embodiments;

FIG. 2 illustrates an example of a PUSCH repetition in accordance with at least some example embodiments;

FIG. 3 illustrates an example of nTDWs determination for joint channel estimation in accordance with at least some example embodiments;

FIG. 4 illustrates an example of aTDWs determination for joint channel estimation in accordance with at least some example embodiments;

FIG. 5 illustrates an example TDD pattern determination in accordance with at least some example embodiments;

FIG. 6 illustrates first examples of cyclic and sequential mapping patterns in accordance with at least some example embodiments;

FIG. 7 illustrates second examples cyclic and sequential mapping patterns in accordance with at least some example embodiments;

FIG. 8 illustrates a signaling graph in accordance with at least some example embodiments;

FIG. 9 illustrates an example apparatus capable of supporting at least some example embodiments;

FIG. 10 illustrates a flow graph of a first method in accordance with at least some example embodiments.

### EXAMPLE EMBODIMENTS

Channel estimation may be enhanced by the procedures described herein. More specifically, channel estimation may be enhanced by enabling and/or optimizing joint channel estimation. A mapping pattern may be determined for mapping between at least two reference signal resource sets, such as Sounding Reference Signal, SRS, resource sets, depending on whether joint channel estimation is enabled for an apparatus, like a User Equipment, UE. For instance, if joint channel estimation is disabled for the apparatus, the mapping pattern may be determined according to a legacy procedure and the legacy procedure may be applied for selecting between a cyclic mapping pattern and a sequential mapping pattern. On the other hand, if joint channel estimation is enabled for the apparatus, the mapping pattern may comprise using a first reference signal set on a first set of consecutive slots and using a second reference signal set on a second set of consecutive slots. In such a case, the mapping pattern may further depend on the duplexing mode configured for the apparatus.

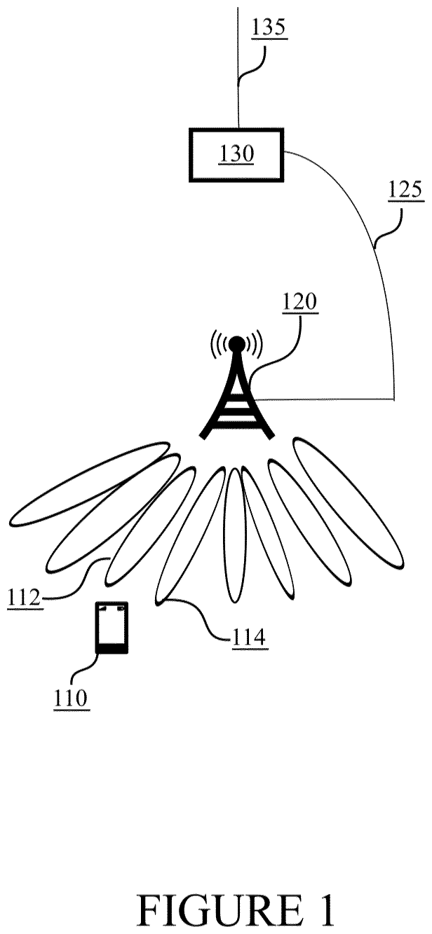

FIG. 1 illustrates an example of a network scenario in accordance with at least some example embodiments. According to the example scenario of FIG. 1, there may be a beam-based wireless communication system, which comprises UE 110, wireless network node 120 and core network element 130. UE 110 may be connected to wireless network node 120 via air interface using beams 112 and 114, either simultaneously or one at a time.

UE 110 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal. In the example system of FIG. 1, UE 110 may communicate wirelessly with wireless network node 120 for example via beam 112 and/or beam 114. Wireless network node 120 may be considered as a serving node for UE 110 and one cell of wireless network node 120 may be a serving cell for UE 110.

Air interface between UE 110 and wireless network node 120 may be configured in accordance with a Radio Access Technology, RAT, which both UE 110 and wireless network node 120 are configured to support. Examples of cellular RATs include Long Term Evolution, LTE, New Radio, NR, which may also be known as fifth generation, 5G, radio access technology and MulteFire.

For example in the context of LTE, wireless network node 120 may be referred to as eNB while wireless network node 120 may be referred to as gNB in the context of NR. In some example embodiments, wireless network node 120 may be referred to as a Transmission and Reception Point, TRP, or control multiple TRPs that may be co-located or non-co-located. In any case, example embodiments of the present disclosure are not restricted to any particular wireless technology. Instead, example embodiments may be exploited in any wireless communication system, wherein joint channel estimation is used.

Wireless network node 120 may be connected, directly or via at least one intermediate node, with core network 130 via interface 125. Core network 130 may be, in turn, coupled via interface 135 with another network (not shown in FIG. 1), via which connectivity to further networks may be obtained, for example via a worldwide interconnection network. Wireless network node 120 may be connected, directly or via at least one intermediate node, with core network 130 or with another core network.

For instance in 3rd Generation Partnership Project, 3GPP, Rel-15/16, an uplink transport block may be transmitted per uplink (or special) slot via a Physical Uplink Shared Channel, PUSCH. In other words, resource allocation for a single PUSCH transmission may be limited within a slot. Therefore, a feature called PUSCH aggregation, which may be referred to as PUSCH repetition type A to avoid confusion with PUSCH repetition type B feature introduced in 3GPP Rel-16 for ultra-reliable low latency applications, was firstly specified in 3GPP Rel-15 and further enhanced in 3GPP Rel-16/17.

PUSCH repetition type A may be used to allow repeating the transmission of a transmission block within a slot multiple times across K slots. The number of repetitions K may be configured by Radio Resource Control, RRC, signalling, by wireless network node 120 for example. According to 3GPP Rel-15/16, said K slots must be consecutive. The same resource allocation for PUSCH may be applied across said K consecutive slots, which means that the same starting symbol S and length L should be applied for each PUSCH in said K consecutive slots. If the number of available symbols for an uplink transmission in a slot of said K consecutive slots is less than L, for example due to overlapping with downlink symbols, then PUSCH repetition is not to be transmitted in the slot. The number of repetitions counter may be updated anyway, which means that the slot would be still counted in said K PUSCH repetitions.

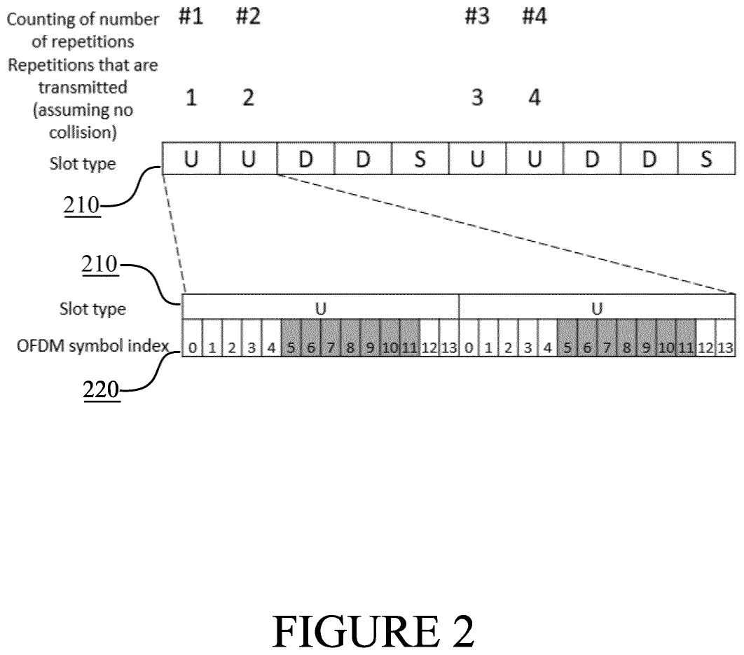

FIG. 2 illustrates an example of a PUSCH repetition. More specifically, FIG. 2 illustrates an example of PUSCH repetition, for example type A in 3GPP Rel-15/16, with K=4, S=5 and L=7, and DDSUU (10D:2G:2U) Time Division Duplexing, TDD, pattern. As the indicated number of repetitions K=4, 4 consecutive slots are counted but repetitions are transmitted only on two of them due to overlap with downlink slots. In FIG. 2, slot type is denoted by 210 and Orthogonal Frequency Division Multiplexing, OFDM, symbol index is denoted by 220.

Joint channel estimation for PUSCH and Physical Uplink Control Channel, PUCCH, coverage enhancements may be exploited to allow wireless network node 120, such as a gNB, to jointly process Demodulation Reference Signals, DM-RSs, from multiple PUSCH or PUCCH transmissions, in order to improve uplink channel estimation performance. Joint channel estimation for PUSCH and PUCCH may also be referred to as DMRS-bundling feature. In case of joint channel estimation, UE 110 should be able to ensure the power consistency and phase continuity across the DM-RS symbols that are going to be used by wireless network node 120 for joint channel estimation. To align the understanding between UE 110 and wireless network node 120 on which DM-RS symbols are bundled, a Time-Domain Window, TDW, may be used to define the time duration within which UE 110 must maintain power consistency and phase continuity across the DM-RS symbols of the PUSCH or PUCCH transmissions.

The TDW determination may comprise two steps. As a first step, one or multiple nominal TDWs, nTDWs, may be determined. Said nTDWs may cover the entire PUSCH repetition, transport block over multiple slots or PUCCH repetition. Wireless network node 120 may hence configure a nominal window with length L first, which may be counted in a number of consecutive slots, starting from the first slot of the PUSCH or PUCCH transmissions. This nTDW may be repeated across the entire PUSCH or PUCCH transmissions.

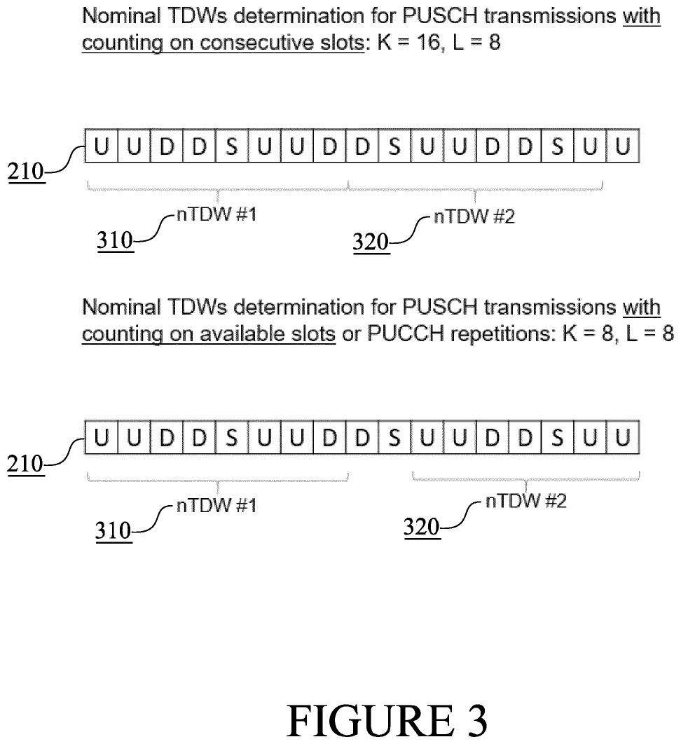

FIG. 3 illustrates an example of nTDWs determination for joint channel estimation. Determination of nTDWs may be different for different ways of counting, as illustrated in FIG. 3. In FIG. 3, slot type is denoted by 210 as in FIG. 2. In addition, first nTDW is denoted by 310 and second nTDW is denoted by 320.

The counting method for the PUSCH repetition may be based on consecutive slots and in such a case, nTDWs may be always back-to-back. On the other hand, if the counting method for the PUSCH repetition is based on available slot, if it is transport block over multiple slots transmission or if it is PUCCH repetition, which may all be counted on available slots, the next nTDW may be determined based on an available slot. More specifically, the start of the next nTDW in that case may be the first available slot right after the last slot of a previous nTDW. Length L may be configured using RRC signalling and not be greater than a maximum value Lₘₐₓ, wherein value Lₘₐₓ may be subject to the capability of UE 110. If value L is not configured, then it may be calculated as minimum of value Lₘₐₓ and the time duration in consecutive slots of the entire PUSCH or PUCCH transmissions.

As a second step, one or multiple actual TDWs, aTDWs, may be determined within each nTDW. The rationale behind this step is that, although multiple nTDWs cover the entire duration of PUSCH transmissions or PUCCH repetitions, there is a possibility that some events may happen and break power consistency and phase continuity within each nTDW. Therefore, if such events happen then an nTDW may be fragmented into several aTDWs, and UE 110 may only need to maintain power consistency and phase continuity within each aTDW.

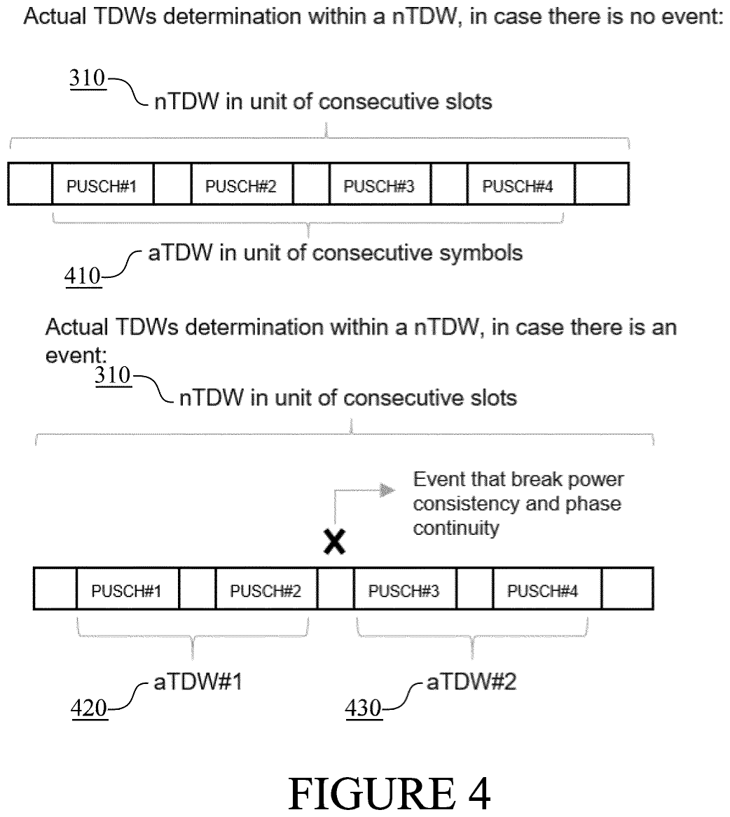

FIG. 4 illustrates an example of aTDWs determination for joint channel estimation. More specifically, aTDWs may be determined as follows, as illustrated in FIG. 4. In FIG. 4, nTDW is denoted by 310 as in FIG. 3. In addition, aTDW in unit of consecutive symbols is denoted by 410 while first aTDW is denoted by 420 and second aTDW is denoted by 430.

In case there is no event, an aTDW may be almost equal to an nTDW except that the aTDW may be counted in symbols, instead of slots. More specifically, the start of a first aTDW may be the first symbol of the first PUSCH or PUCCH transmission within the nTDW and the end of the last aTDW may be the last symbol of the last PUSCH or PUCCH transmission within the nTDW. However, if there is an event, the end of one aTDW may be the last symbol of a PUSCH or PUCCH transmission before the event, and the start of a subsequent aTDW may be the first symbol of the PUSCH or PUCCH transmission after the event.

For instance, according to, events that break power consistency and phase continuity may be defined in Section 6.1.7 of 3GPP TS 38.214 Rel-17 and comprise at least that:
For any two consecutive PUSCH transmissions of PUSCH repetition type A, or PUSCH repetition type B, and when two SRS resource sets are configured in srs-ResourceSetToAddModList or srs-ResourceSetToAddModListDCI-0-2 with higher layer parameter usage in SRS-ResourceSet set to ‘codebook’ or ‘noncodebook’, a different SRS resource set association is used for the two PUSCH transmissions of PUSCH repetition type A, or PUSCH repetition type B, according to Clause 6.1.2.1 of 3GPP TS 38.214;
For any two consecutive PUCCH transmissions of PUCCH repetition, and when a PUCCH resource used for repetitions of a PUCCH transmission by UE 110 includes first and second spatial relations or first and second sets of power control parameters, as described in 3GPP TS 38.321 and in clause 7.2.1 of 3GPP TS 38.213, different spatial relations or different power control parameters may be used for the two PUCCH transmissions of PUCCH repetition, according to Clause 9.2.6 of 3GPP TS 38.213.

In case of TDD configuration, for example in 5G NR, the uplink downlink transmission pattern may be configured by tdd-UL-DLConfigurationCommon, which may be broadcasted as a part of System Information Block, SIB1. This uplink/downlink pattern may be further refined by a tdd-UL-DLConfigurationDedicated configuration. tdd-UL-DLConfigurationCommon may be used to configure up to two patterns (pattern1 and pattern2), each comprising for example parameters, such as dl-UL-TransmissionPeriodicity in ms, which can be converted to a number of slots using a reference subcarrier spacing, nrofDownlinkSlots. nrofDownlinkSymbols, nrofUplinkSymbols, and nrofUplinkSlots.

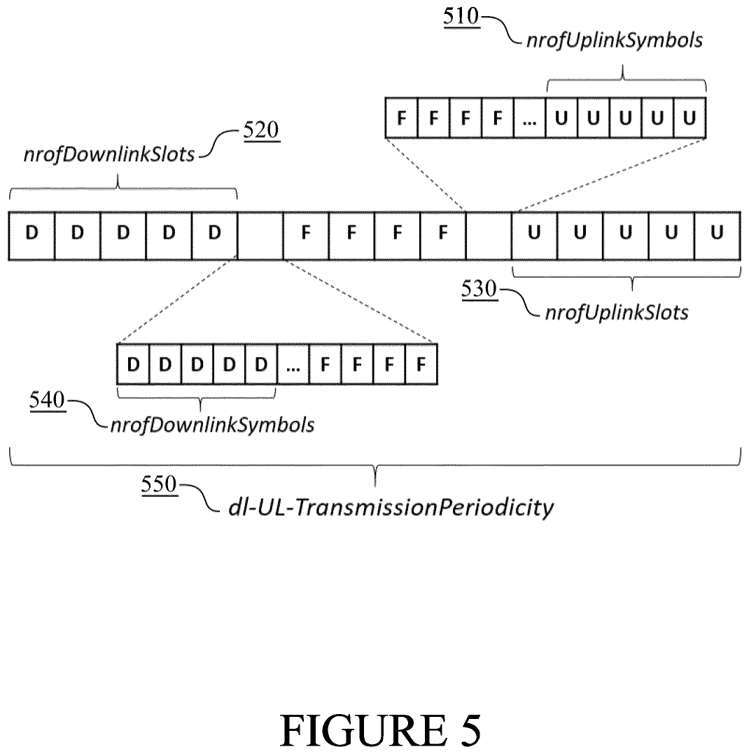

FIG. 5 illustrates an example TDD pattern determination in accordance with at least some example embodiments. In FIG. 5, nrofUplinkSymbols is denoted by 510, nrofDownlinkSlots is denoted by 520, nrofUplinkSlots is denoted by 530, nrofDownlinkSymbols is denoted by 540 and dl-UL-TransmissionPeriodicity is denoted by 550.

In the example of FIG. 5, parameters may be configured in tdd-UL-DLConfigurationCommon for one pattern for TDD pattern determination, where D, F and U stand for downlink, flexible and uplink slot/symbol, respectively. If two patterns are configured (i.e., both pattern1 and pattern2 are included in tdd-UL-DLConfigurationCommon), then the second pattern may follow the first pattern, and the pair of patterns may be repeated with a period, which equals to a sum of dl-UL-TransmissionPeriodicity parameters configured in pattern1 and pattern2.

In 3GPP Rel-17, multiple-TRP, m-TRP, feature may be introduced to provide the possibility of transmitting different PUSCH repetitions towards different TRPs. Transmission of different PUSCH repetitions towards different TRPs may be supported by configuring two SRS resource sets, where said two SRS resource sets may correspond to two TRPs, and repetitions towards each TRP may follow the SRS resource set associated with that TRP.

Currently, section 6.1.2.1 of 3GPP TS 38.214 only specifies the mapping between SRS resource sets and PUSCH repetitions for Rel-15/16 PUSCH repetition type A, wherein the number of repetitions are counted on consecutive slots. Such mapping does not consider 3GPP Rel-17 coverage enhancements though, which include at least the joint channel estimation feature, which may also be applicable for Rel-15/16 PUSCH repetition type A.

For instance, if the SRS resource set indicator field in Downlink Control Information, DCI, indicates codepoint “10” or “11”, i.e., when two SRS resource sets are used for mapping, cyclic mapping or sequential mapping of the SRS resource sets may be applied for K consecutive slots, wherein K is the number of repetitions. Although the mapping may be done for all K consecutive slots, only uplink (or special) slots with sufficient and valid uplink symbols may be used for PUSCH repetitions. In addition, the use of different SRS resource sets between two consecutive PUSCH/PUCCH transmissions may also be considered as an event that breaks power consistency and phase continuity for joint channel estimation between the two PUSCH/PUCCH transmissions. Therefore, the legacy cyclic mapping and sequential mapping of SRS resource sets are not optimal for joint channel estimation. When available, both m-TRP and joint channel estimation features for PUSCH repetition type A would be helpful for extending coverage, particularly if used together.

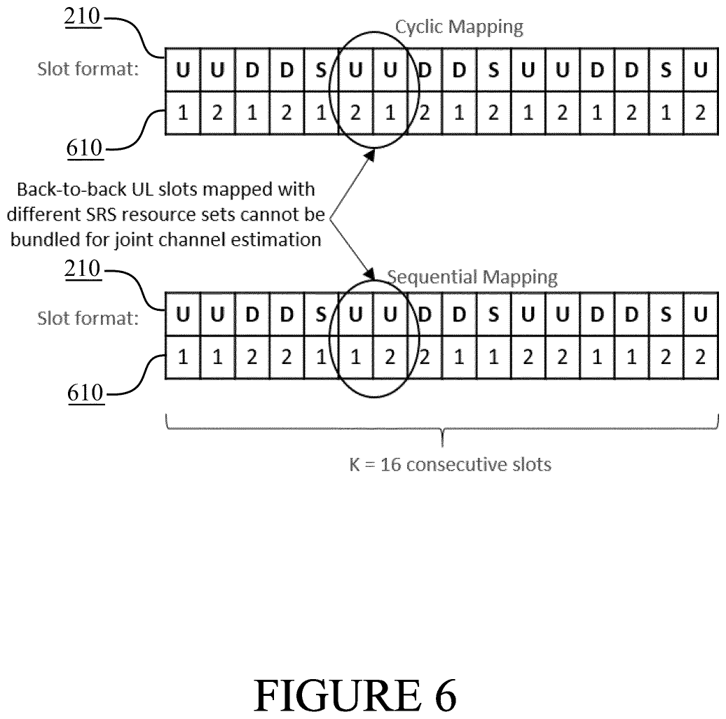

FIG. 6 illustrates examples cyclic mapping and sequential mapping in accordance with at least some example embodiments. In FIG. 6, slot type/format is denoted by 210 as in FIG. 2 and SRS resource set index is denoted by 610.

FIG. 6 illustrates examples of using legacy cyclic mapping and sequential mapping of SRS resource sets for 3GPP Rel-15/16 PUSCH repetition type A assuming K=16, S=5, L=7 and DDSUU (10D:2G:2U) TDD pattern. As illustrated, for both cyclic mapping and sequential mapping, there may exist the cases wherein back-to-back uplink slots may be mapped with different SRS resource sets, and in such a case, joint channel estimation could not be applied for PUSCH transmissions on these slots.

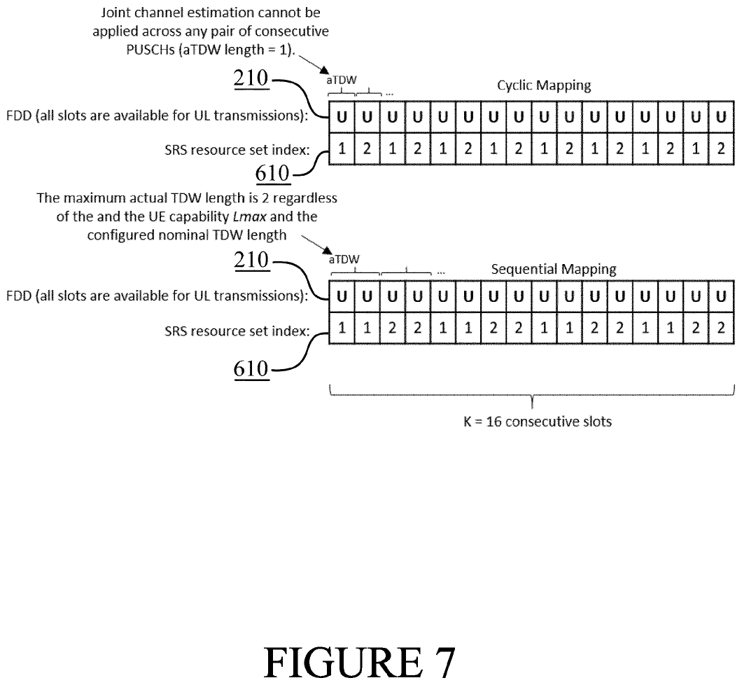

FIG. 7 illustrates second examples cyclic mapping and sequential mapping in accordance with at least some example embodiments. In FIG. 7, slot type/format is denoted by 210 as in FIG. 2 and SRS resource set index is denoted by 610 as in FIG. 6.

As illustrated in FIG. 7, legacy cyclic mapping and sequential mapping of SRS resource sets may also have issues if used together with joint channel estimation in Frequency Division Duplexing, FDD. In FDD, the chance for an aTDW to be equal to an nTDW may be high, given that the consecutive uplink slots may not interrupted by downlink slots, downlink transmissions or monitoring. However, as illustrated in FIG. 7, with cyclic mapping in FDD, joint channel estimation may not be applied across any pair of consecutive PUSCHs since the consecutive PUSCHs may be mapped with different SRS resource sets. Also, with sequential mapping in FDD, the maximum aTDW length would be 2 regardless of the nTDW length (which may be configured to be equal to the maximum capability of slots bundling reported by UE 110).

The above mentioned challenges are also applicable for PUCCH repetitions, wherein the mapping of PUCCH repetitions to m-TRP may be realized in the form of mapping different spatial settings or different power control parameters sets on different PUCCH repetitions. For example in 3GPP Rel-17, cyclic mapping and sequential mapping may also be applied on PUCCH repetitions. However, different from the mapping for PUSCH repetitions which may be done on consecutive slots, the mapping for PUCCH repetitions may be done on the slots available for uplink transmissions.

Example embodiments of the present disclosure therefore address the above mentioned challenges and provide a mapping scheme for mapping reference signal resource sets, such as SRS resource sets, or spatial settings or power control parameters sets to uplink transmissions, such as PUSCH repetitions or PUCCH repetitions or slots. Example embodiments of the present disclosure may be exploited for example for m-TRP PUSCH repetition type A or m-TRP PUCCH repetitions, to enable and/or optimize joint channel estimation across the PUSCH repetitions or PUCCH repetitions corresponding to each TRP.

In some example embodiments, UE 110 may determine a mapping approach, i.e., mapping pattern, for the mapping between at least two reference signal resource sets, such as SRS resource sets, and K consecutive slots, wherein K is the number of uplink transmissions, such as repetitions for PUSCH repetition type A or for the mapping between at least two spatial settings or at least two power control parameters sets, and K slots available for uplink transmissions, wherein K is the number of uplink transmissions, such as repetitions for PUCCH repetition. The determination about the mapping pattern may be based at least on one of the following factors:
enabling/disabling of joint channel estimation feature;
duplexing mode (TDD or FDD); and
an RRC parameter (this factor may be added for completeness).

When it is determined that the joint channel estimation feature is enabled for UE 110, the mapping pattern between the at least two reference signal resource sets or at least two spatial settings or at least two power control parameters sets and the K slots may be one of the following options:
Option 1 (Mapping pattern associated with the TDD pattern): The first and second reference signal resource sets, like SRS resource sets, may be applied to a first set of N₁ consecutive slots and a subsequent, second set of N₂ consecutive slots of K consecutive slots, respectively. That is, UE 110 may determine, when the joint channel estimation is enabled for UE 110, that the mapping pattern comprises using a first reference signal set on a first set of consecutive slots and using a second reference signal set on a second set of consecutive slots of K consecutive slots or K slots available for uplink transmission. In general, a number of the first set of consecutive slots and a number of the second set of consecutive slots are larger than two and the second set of consecutive slots is subsequent to the first set of consecutive slots. Then, the same reference signal resource set mapping pattern may continue to the remaining slots of K consecutive slots, wherein N₁=N₂<K may be the length of one cycle of a TDD pattern (e.g., N=5 for DDSUU) if one pattern is configured. So a number of the first set of consecutive slots may be the same as a number of the second set of consecutive slots, and equal to a length of one cycle of a TDD pattern, when one TDD pattern is configured for UE 110. Alternatively, N1<K and N2<K may be the lengths of a first cycle of TDD pattern and a second cycle of TDD pattern, respectively, if two patterns are configured. In such a case, a number of the first set of consecutive slots equals a length of a first cycle of a TDD pattern and a number of the second set of consecutive slots equals a length of a second cycle of the TDD pattern when two TDD patterns are configured for UE 110.
Option 1a (Mapping pattern associated with the TDD pattern in case of available slot counting for PUCCH or PUSCH repetitions): The first and second reference signal resource sets, like SRS resource sets, or the first and second spatial settings or the first and second power control parameters sets may be applied to a first set of N₁ consecutive slots and a subsequent, second set of N₂ consecutive slots of K slots available for uplink transmission, respectively. That is, UE 110 may determine, when the joint channel estimation is enabled for UE 110, that the mapping pattern comprises using a first reference signal set or a first spatial setting or a first power control parameters set on a first set of consecutive slots of K slots available for uplink transmission and using a second reference signal set or a second spatial setting or a second power control parameters set on a second set of consecutive slots of K slots available for uplink transmission. In general, a number of the first set of consecutive slots and a number of the second set of consecutive slots of K slots available for uplink transmission are larger than two and the second set of consecutive slots is subsequent to the first set of consecutive slots. Then, the same reference signal resource set or spatial setting or power control parameters set mapping pattern may continue to the remaining slots of K slots available for uplink transmission, wherein N₁=N₂<K may be the number of slots available for uplink transmissions in one cycle of a TDD pattern (e.g., N=3 for DSUUU, or N=3 for DDSUU if the S slot is also usable for the uplink transmissions) if one pattern is configured. So a number of the first set of consecutive slots may be the same as a number of the second set of consecutive slots, and equal to a number of slots available for uplink transmissions in one cycle of a TDD pattern, when one TDD pattern is configured for UE 110. Alternatively, N1<K and N2<K may be the number of slots available for uplink transmissions in one cycle of a first TDD pattern and the number of slots available for uplink transmissions in one cycle of a second TDD pattern, respectively, if two patterns are configured. In such a case, a number of the first set of consecutive slots equals a number of slots available for uplink transmissions in one cycle of a first TDD pattern and a number of the second set of consecutive slots equals a number of slots available for uplink transmissions in one cycle of a second TDD pattern when two TDD patterns are configured for UE 110.
Option 2 (Mapping pattern associated with the length of an nTDW, may be applicable for both, TDD and FDD): The first and second reference signal resource sets, like SRS resource sets, or the first and second spatial settings or the first and second power control parameters sets may be applied to a first set of N consecutive slots and a subsequent, second set of N consecutive slots of K consecutive slots or K slots available for uplink transmission, respectively. The same reference signal resource set or spatial setting or power control parameters set mapping pattern may continue to the remaining slots of K consecutive slots or K slots available for uplink transmission, wherein N<K is the length of the nTDW. So a number of the first set of consecutive slots may be the same as a number of the second set of consecutive slots, and equal to a length of an nTDW configured for UE 110.
Option 3 (Mapping pattern associated with an RRC configured sequential mapping window, may be applicable for both, TDD and FDD): The first and second reference signal resource sets, like SRS resource sets, or the first and second spatial settings or the first and second power control parameters sets may be applied to a first set of N consecutive slots and a subsequent, second set of N consecutive slots of K consecutive slots or K slots available for uplink transmission, respectively. The same reference signal resource set or spatial setting or power control parameters set mapping pattern may continue to the remaining slots of K consecutive slots or K slots available for uplink transmission, wherein N<K may be configured by RRC signalling. So a number of the first set of consecutive slots may be the same as a number of the second set of consecutive slots, and configured by wireless network node 120 using RRC signalling.
Option 4 (Mapping pattern associated with the length of an aTDW, may be applicable for both, TDD and FDD): The first and second reference signal resource sets, like SRS resource sets, or the first and second spatial settings or the first and second power control parameters sets may be applied to the consecutive slots or the slots available for uplink transmissions within a first aTDW and to the consecutive slots or the slots available for uplink transmissions within a second aTDW, respectively. That is, the first set of consecutive slots or the slots available for uplink transmissions may be within a first aTDW and the second set of consecutive slots or the slots available for uplink transmissions may be within a second aTDW. The same reference signal resource set or spatial setting or power control parameters set mapping pattern may continue to the remaining aTDWs within K consecutive slots or K slots available for uplink transmission, wherein the aTDWs may be determined without considering the event of reference signal resource sets or spatial settings or power control parameters sets mapping. In other words, with this option, UE 110 may apply a different reference signal resource set or spatial setting or power control parameters set after each event in an nTDW.

When the joint channel estimation feature is disabled for UE 110, the mapping pattern between the at least two reference signal resource sets, like SRS resource sets, and K consecutive slots may consider legacy sequential or cyclic mapping patterns, configured by RRC signalling. That is, UE 110 may determine that the mapping pattern is a cyclic mapping pattern or a sequential mapping pattern when the joint channel estimation is disabled for UE 110.

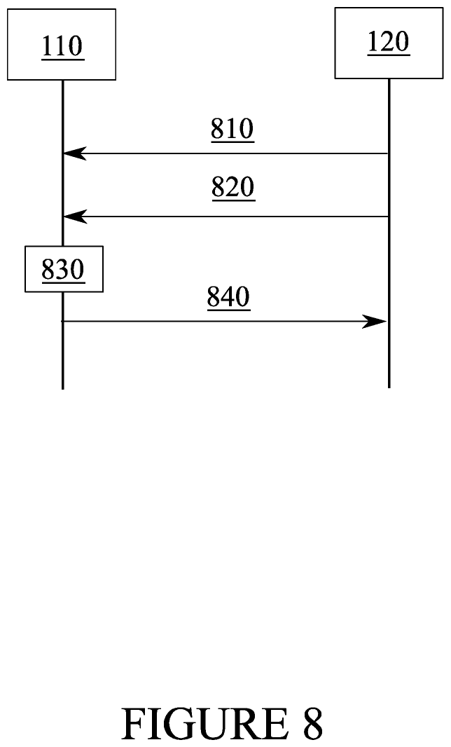

FIG. 8 illustrates a signaling graph in accordance with at least some example embodiments. On the vertical axes are disposed, from the left to the right, UE 110 and wireless network node 120. Time advances from the top towards the bottom.

At step 810, wireless network node 120, such as a gNB, may configure a duplexing mode, like TDD or FDD, for UE 110 and enable or disable joint channel estimation for UE 110. At step 820, wireless network node 120 may schedule uplink transmissions, such as PUSCH repetition type A transmissions with different reference signal resource sets, such as SRS resource sets. That is, wireless network node may transmit, at step 820, a configuration configuring UE 110 to transmit said uplink transmissions using at least two different reference signal resource sets.

At step 830, UE 110 may determine a mapping pattern for transmitting using the at least two different reference signal resource sets, wherein the mapping pattern may depend at least on whether joint channel estimation is enabled or disabled for UE 110. For instance, UE 110 may determine a mapping pattern for the mapping between at least two SRS resource sets and K consecutive slots, wherein K is the number of repetitions for PUSCH repetition type A.

Said determination, at step 830, may be performed by UE 110 as follows. If joint channel estimation is disabled for UE 110, UE 110 may determine to apply the legacy procedure for selecting between the legacy cyclic mapping and sequential mapping.

On the other hand, if joint channel estimation is enabled for UE 110 and if the duplexing mode configured for UE 110 is TDD, Option 1 may be selected, e.g., the first and second SRS resource sets may be applied to a first set of N1 consecutive slots and a subsequent, second set of N2 consecutive slots of K consecutive slots, respectively. The same SRS resource set mapping pattern may continue to the remaining slots of K consecutive slots, wherein N1=N2<K may be the length of one cycle of a TDD pattern if one pattern is configured or N1<K and N2<K may be the length of a first cycle of a TDD pattern and a second cycle of the TDD pattern, respectively, if two patterns are configured.

Else, if joint channel estimation is enabled for UE 110 and if the duplexing mode configured for UE 110 is FDD, Option 2 may be selected. For instance, the first and second SRS resource sets may be applied to a first set of N consecutive slots and a subsequent, second set of N consecutive slots of K consecutive slots, respectively. The same SRS resource set mapping pattern may continue to the remaining slots of K consecutive slots, wherein N<K may be the length of an nTDW or may be separately configured/indicated, possibly using RRC signalling. Wireless network node 120 may determine the mapping pattern for receiving using on the at least two SRS resource sets similarly.

At step 840, UE 110 may apply the determined mapping pattern and transmit accordingly. That is, UE 110 may, at step 840, transmit uplink transmissions using at least two different reference signal resource sets in accordance with the determined mapping pattern. For instance, UE 110 may transmit the PUSCH repetition type A, wherein the determined mapping pattern is one of the Options 1 to 4, when joint channel estimation is enabled.

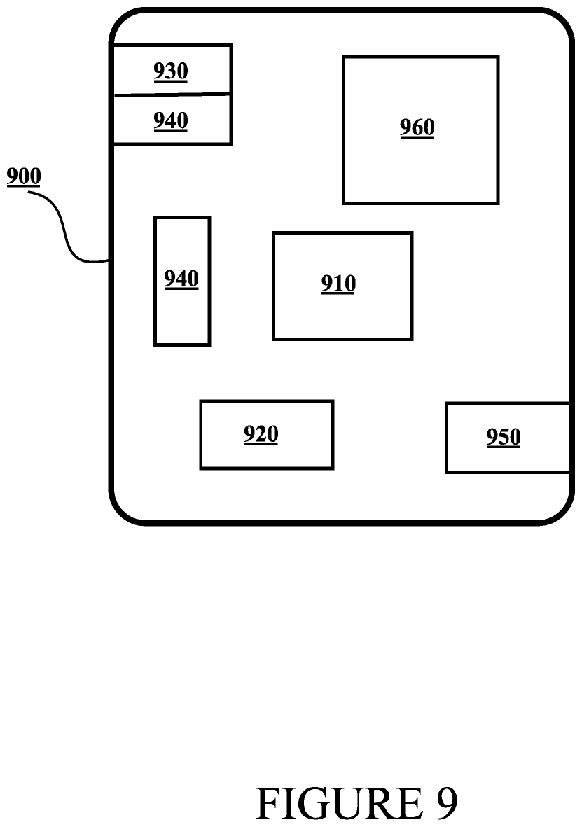

FIG. 9 illustrates an example apparatus capable of supporting at least some example embodiments. Illustrated is device 900, which may comprise, for example, UE 110 or wireless network node 120, or a control device configured to control the functioning thereof, possibly when installed therein. Comprised in device 900 is processor 910, which may comprise, for example, a single- or multi-core processor wherein a single-core processor comprises one processing core and a multi-core processor comprises more than one processing core. Processor 910 may comprise, in general, a control device. Processor 910 may comprise more than one processor. Processor 910 may be a control device. A processing core may comprise, for example, a Cortex-A8 processing core manufactured by ARM Holdings or a Steamroller processing core produced by Advanced Micro Devices Corporation. Processor 910 may comprise at least one Qualcomm Snapdragon and/or Intel Atom processor. Processor 910 may comprise at least one application-specific integrated circuit, ASIC. Processor 910 may comprise at least one field-programmable gate array, FPGA. Processor 910 may be means for performing method steps in device 900. Processor 910 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 900 may comprise memory 920. Memory 920 may comprise random-access memory and/or permanent memory. Memory 920 may comprise at least one RAM chip. Memory 920 may comprise solid-state, magnetic, optical and/or holographic memory, for example. Memory 920 may be at least in part accessible to processor 910. Memory 920 may be at least in part comprised in processor 910. Memory 920 may be means for storing information. Memory 920 may comprise computer instructions that processor 910 is configured to execute. When computer instructions configured to cause processor 910 to perform certain actions are stored in memory 920, and device 900 overall is configured to run under the direction of processor 910 using computer instructions from memory 920, processor 910 and/or its at least one processing core may be considered to be configured to perform said certain actions. Memory 920 may be at least in part comprised in processor 910. Memory 920 may be at least in part external to device 900 but accessible to device 900.

Device 900 may comprise a transmitter 930. Device 900 may comprise a receiver 940. Transmitter 930 and receiver 940 may be configured to transmit and receive, respectively, information in accordance with at least one cellular or non-cellular standard. Transmitter 930 may comprise more than one transmitter. Receiver 940 may comprise more than one receiver. Transmitter 930 and/or receiver 940 may be configured to operate in accordance with Global System for Mobile communication, GSM, Wideband Code Division Multiple Access, WCDMA, Long Term Evolution, LTE, and/or 5G/NR standards, for example.

Device 900 may comprise a Near-Field Communication, NFC, transceiver 950. NFC transceiver 950 may support at least one NFC technology, such as Bluetooth, Wibree or similar technologies.

Device 900 may comprise User Interface, UI, 960. UI 960 may comprise at least one of a display, a keyboard, a touchscreen, a vibrator arranged to signal to a user by causing device 900 to vibrate, a speaker and a microphone. A user may be able to operate device 900 via UI 960, for example to accept incoming telephone calls, to originate telephone calls or video calls, to browse the Internet, to manage digital files stored in memory 920 or on a cloud accessible via transmitter 930 and receiver 940, or via NFC transceiver 950, and/or to play games.

Device 900 may comprise or be arranged to accept a user identity module 970. User identity module 970 may comprise, for example, a Subscriber Identity Module, SIM, card installable in device 900. A user identity module 970 may comprise information identifying a subscription of a user of device 900. A user identity module 970 may comprise cryptographic information usable to verify the identity of a user of device 900 and/or to facilitate encryption of communicated information and billing of the user of device 900 for communication effected via device 900.

Processor 910 may be furnished with a transmitter arranged to output information from processor 910, via electrical leads internal to device 900, to other devices comprised in device 900. Such a transmitter may comprise a serial bus transmitter arranged to, for example, output information via at least one electrical lead to memory 920 for storage therein. Alternatively to a serial bus, the transmitter may comprise a parallel bus transmitter. Likewise processor 910 may comprise a receiver arranged to receive information in processor 910, via electrical leads internal to device 900, from other devices comprised in device 900. Such a receiver may comprise a serial bus receiver arranged to, for example, receive information via at least one electrical lead from receiver 940 for processing in processor 910. Alternatively to a serial bus, the receiver may comprise a parallel bus receiver.

Device 900 may comprise further devices not illustrated in FIG. 9. For example, where device 900 comprises a smartphone, it may comprise at least one digital camera. Some devices 900 may comprise a back-facing camera and a front-facing camera, wherein the back-facing camera may be intended for digital photography and the front-facing camera for video telephony. Device 900 may comprise a fingerprint sensor arranged to authenticate, at least in part, a user of device 900. In some example embodiments, device 900 lacks at least one device described above. For example, some devices 900 may lack a NFC transceiver 950 and/or user identity module 970.

Processor 910, memory 920, transmitter 930, receiver 940, NFC transceiver 950, UI 960 and/or user identity module 970 may be interconnected by electrical leads internal to device 900 in a multitude of different ways. For example, each of the aforementioned devices may be separately connected to a master bus internal to device 900, to allow for the devices to exchange information. However, as the skilled person will appreciate, this is only one example and depending on the example embodiment, various ways of interconnecting at least two of the aforementioned devices may be selected without departing from the scope of the example embodiments.

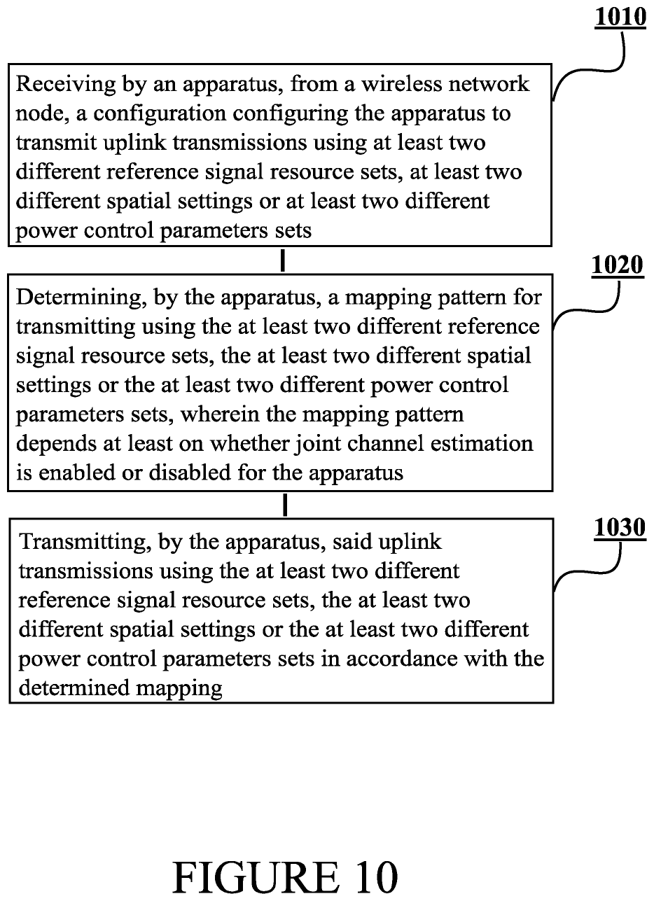

FIG. 10 is a flow graph of a first method in accordance with at least some example embodiments. The apparatus of the first method may be UE 110 or a control device configured to control the functioning thereof, possibly when installed therein. That is, the steps of the first method may be performed by UE 110 or by a control device configured to control the functioning thereof, possibly when installed therein.

The first method may comprise, at step 1010, receiving by an apparatus, from a wireless network node, a configuration configuring the apparatus to transmit uplink transmissions using at least two different reference signal resource sets, at least two different spatial settings or at least two different power control parameters sets. The first method may also comprise, at step 1020, determining, by the apparatus, a mapping pattern for transmitting using the at least two different reference signal resource sets, the at least two different spatial settings or the at least two different power control parameters sets, wherein the mapping pattern depends at least on whether joint channel estimation is enabled or disabled for the apparatus. Finally, the first method may comprise, at step 1030, transmitting, by the apparatus, said uplink transmissions using the at least two different reference signal resource sets, the at least two different spatial settings or the at least two different power control parameters sets in accordance with the determined mapping pattern.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, such as, for example, UE 110 or wireless network node 120, may comprise means for carrying out the example embodiments described above and any combination thereof.

In an example embodiment, a computer program may be configured to cause a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, such as, for example, UE 110 or wireless network node 120, may comprise at least one processor, and at least one memory including computer program code, wherein the at least one memory and the computer program code are configured to, with the at least one processor, cause the apparatus at least to perform the example embodiments described above and any combination thereof.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the disclosure. One skilled in the relevant art will recognize, however, that the disclosure can be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the example embodiments in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some example embodiments find industrial application in cellular communication networks, for example in 3GPP networks, wherein joint channel estimation is used.

### ACRONYMS LIST

3GPP 3rd Generation Partnership Project
aTDW actual TDW
DCI Downlink Control Information
DM-RS Demodulation Reference Signal
FDD Frequency Division Duplexing
GSM Global System for Mobile communication
IoT Internet of Things
LTE Long-Term Evolution
M2M Machine-to-Machine
m-TRP multiple TRP
NFC Near-Field Communication
NLOS Non-Line-of-Sight
nTDW nominal TDW
OFDM Orthogonal Frequency Division Multiplexing
PUCCH Physical Uplink Control Channel
PUSCH Physical Uplink Shared Channel
RAN Radio Access Network
RAT Radio Access Technology
RRC Radio Resource Control
SIB System Information Block
SRS Sounding Reference Signal
TDD Time Division Duplexing
TDW Time-Domain Window
TRP Transmission and Reception Point
UE User Equipment
UI User Interface
WCDMA Wideband Code Division Multiple Access
WiMAX Worldwide Interoperability for Microwave Access
WLAN Wireless Local Area Network

### REFERENCE SIGNS LIST

| | |
|---|---|
| 110 | UE |
| 112, 114 | Beams |
| 120 | Wireless network node |
| 125, 135 | Wired interfaces |
| 130 | Core Network |
| 210 | Slot type |
| 220 | Symbol index |
| 310 | First nTDW |
| 320 | Second nTDW |
| 410 | aTDW in unit of consecutive symbols |
| 420 | First aTDW |
| 430 | Second aTDW |
| 510 | nrofUplinkSymbols |
| 520 | nrofDownlinkSlots |
| 530 | nrofUplinkSlots |
| 540 | nrofDownlinkSymbols |
| 550 | dl-UL-TransmissionPeriodicity |
| 610 | SRS resource set index |
| 810-840 | Steps in the signaling graph of FIG. 8 |
| 900-970 | Structure of the apparatus of FIG. 9 |
| 1010-1030 | Phases of the first method in FIG. 10 |

1-18. (canceled)

19. An apparatus, comprising:
a memory storing computer readable instructions; and
processing circuitry configured to execute the computer readable instructions to cause the apparatus to:
receive, from a wireless network node, a configuration configuring the apparatus to transmit uplink transmissions using at least two different reference signal resource sets, at least two different spatial settings or at least two different power control parameters sets;
determine a mapping pattern for transmitting said uplink transmissions using the at least two different reference signal resource sets, the at least two different spatial settings or the at least two different power control parameters sets, wherein the mapping pattern depends at least on whether joint channel estimation is enabled or disabled for the apparatus; and
transmit said uplink transmissions using the at least two different reference signal resource sets, the at least two different spatial settings or the at least two different power control parameters sets in accordance with the determined mapping pattern.

20. The apparatus according to claim 19, wherein the uplink transmissions comprise Physical Uplink Shared Channel (PUSCH) repetitions and the reference signal resource sets comprise Sounding Reference Signal (SRS) resource sets.

21. The apparatus according to claim 19, wherein the uplink transmissions comprise Physical Uplink Control Channel (PUCCH) repetitions.

22. The apparatus according to claim 19, wherein the apparatus is further caused to:
determine the mapping pattern for transmitting the at least two different reference signal resource sets, the at least two different spatial settings or the at least two different power control parameters sets depending at least on a duplexing mode configured for the apparatus.

23. The apparatus according to claim 22, wherein the duplexing mode is Time Division Duplexing (TDD) or Frequency Division Duplexing (FDD).

24. The apparatus according to claim 19, wherein the apparatus is further caused to:
determine, when the joint channel estimation is enabled for the apparatus, that the mapping pattern comprises using a first reference signal set or a first spatial setting or a first power control parameters set on a first set of slots and
use a second reference signal set or a second spatial setting or a second power control parameters set on a second set of slots, wherein a number of the first set of slots and a number of the second set of slots are larger than two and the second set of slots is subsequent to the first set of slots.

25. The apparatus according to claim 24, wherein
a number of the first set of slots is the same as a number of the second set of slots, and equals a length of one cycle of a TDD pattern, when one TDD pattern is configured for the apparatus; or
a number of the first set of slots equals a length of one cycle of a first TDD pattern and a number of the second set of slots equals a length of one cycle of a second TDD pattern when two TDD patterns are configured for the apparatus.

26. The apparatus according to claim 24, wherein
a number of the first set of slots is the same as a number of the second set of slots, and equals a number of slots available for uplink transmissions in one cycle of a TDD pattern; or
a number of the first set of slots equals a number of slots available for uplink transmissions in one cycle of a first TDD pattern and a number of the second set of slots equals a number of slots available for uplink transmissions in one cycle of a second TDD pattern when two TDD patterns are configured for the apparatus.

27. The apparatus according to claim 24, wherein
a number of the first set of slots is the same as a number of the second set of slots, and equals a length of a nominal time domain window configured for the apparatus.

28. The apparatus according to claim 24, wherein
a number of the first set of slots is the same as a number of the second set of slots, and configured by the wireless network node using Radio Resource Control (RRC) signalling.

29. The apparatus according to claim 24, wherein
the first set of slots is within a first actual time domain window and the second set of slots is within a second actual time domain window.

30. The apparatus according to claim 24, wherein
the slots in the first and the second set of slots are consecutive slots.

31. The apparatus according to claim 24, wherein
the slots in the first and the second set of slots are the slots available for uplink transmissions.

32. The apparatus according to claim 19, wherein the apparatus is a User Equipment (UE) or a control device configured to control functioning of the UE.

33. An apparatus, comprising:
a memory storing computer readable instructions; and
processing circuitry configured to execute the computer readable instructions to cause the apparatus to:
transmit, to a User Equipment (UE) a configuration configuring the UE to transmit uplink transmissions using at least two different reference signal resource sets, at least two different spatial settings or at least two different power control parameters sets;
determine a mapping pattern for receiving using one of the at least two different reference signal resource sets, the at least two different spatial settings or the at least two different power control parameters sets, wherein the mapping pattern depends at least on whether joint channel estimation is enabled or disabled for the UE; and
receive said uplink transmissions using said one of the at least two different reference signal resource sets, the at least two different spatial settings or the at least two different power control parameters sets in accordance with the determined mapping pattern.

34. A method, comprising:
receiving by an apparatus, from a wireless network node, a configuration configuring the apparatus to transmit uplink transmissions using at least two different reference signal resource sets, at least two different spatial settings or at least two different power control parameters sets;
determining, by the apparatus, a mapping pattern for transmitting using the at least two different reference signal resource sets, the at least two different spatial settings or the at least two different power control parameters sets, wherein the mapping pattern depends at least on whether joint channel estimation is enabled or disabled for the apparatus; and
transmitting, by the apparatus, said uplink transmissions using the at least two different reference signal resource sets, the at least two different spatial settings or the at least two different power control parameters sets in accordance with the determined mapping pattern.

35. The method according to claim 34, wherein the uplink transmissions comprise Physical Uplink Shared Channel (PUSCH) repetitions and the reference signal resource sets comprise Sounding Reference Signal (SRS) resource sets.

36. The method according to claim 34, wherein the uplink transmissions comprise Physical Uplink Control Channel (PUCCH) repetitions.

37. The method according to claim 34, further comprising:
determining the mapping pattern for transmitting the at least two different reference signal resource sets, the at least two different spatial settings or the at least two different power control parameters sets depending at least on a duplexing mode configured for the apparatus.

38. The method according to claim 34, further comprising:
determining, when the joint channel estimation is enabled for the apparatus, that the mapping pattern comprises using a first reference signal set or a first spatial setting or a first power control parameters set on a first set of slots and
using a second reference signal set or a second spatial setting or a second power control parameters set on a second set of slots, wherein a number of the first set of slots and a number of the second set of slots are larger than two and the second set of slots is subsequent to the first set of slots.
